(19) United States
(12) Patent Application Publication
(10) Pub. No.: US 2024/0237694 A1
(43) Pub. Date: Jul. 18, 2024

(54) OIL-IN-WATER EMULSIONS COMPRISING SWEET CORN FLOUR

(71) Applicant: CORN PRODUCTS DEVELOPMENT, INC., WESTCHESTER, IL (US)

(72) Inventors: Katelyn MEYLER, Bridgewater, NJ (US); Quyen NGUYEN, Bridgewater, NJ (US)

(21) Appl. No.: 18/686,017

(22) PCT Filed: Aug. 23, 2022
(86) PCT No.: PCT/US2022/041149

§ 371 Date: Feb. 23, 2024

Related U.S. Application Data
(60) Provisional application No. 63/240,391, filed on Sep. 3, 2021.

(51) Int. Cl. A23L 35/00; A23L 29/10; A23L 29/212; A23L 33/185

(52) U.S. Cl. CPC A23L 35/10; A23L 29/10; A23L 29/212; A23L 33/185

(57) ABSTRACT

The technology disclosed in this specification pertains oil-in-water emulsions comprising a sweet corn flour. In various embodiments the oil-in-water emulsions further comprise pulse protein. Also disclosed are emulsifier compositions comprising a pulse protein and sweet corn flour that can be used in liquid or powdered form to obtain oil-in water emulsions. Embodiments of the disclosed oil-in-water emulsions are long term stable against separation of oil and water as measured by change in oil droplet size over time.

This specification discloses oil-in-water emulsions comprising sweet corn flour. Preferably, the described oil-in-water emulsions further comprise a pulse-protein.

Oil-in-water emulsions are common in various food compositions. Common emulsifiers used to stabilize the emulsion include egg, modified starch (like octenylsuccinic acid modified starches), monoglycerides, or diglycerides. These ingredients may be disfavored by some consumers who, for example, prefer vegan compositions or prefer compositions that do not use modified starch. Pulse proteins have been used as emulsifiers in place of modified starch, egg, monoglycerides, or diglycerides. Such emulsions, however, are comparatively less stable than those using egg, modified starch, monoglycerides, or digylcerides, meaning that in comparatively short periods of time the oil and water of emulsions using pulse protein emulsifiers begin to separate as evidenced by changing oil droplet size in the emulsions. This specification discloses use of sweet corn flour in oil-in-water emulsions, particularly those using pulse protein emulsifiers. Used as described emulsions comprising pulse protein and sweet corn flour are more stable against oil and water separation than emulsions only using pulse protein.

### BRIEF DESCRIPTION OF THE FIGURES

FIG. 1 graphs the oil droplet size distribution of an oil-in-water emulsions comprising chickpea protein without use of sweet corn flour.

FIG. 2 graphs the oil droplet size distribution of an oil-in-water emulsions comprising chickpea protein and using sweet corn flour.

In one aspect the technology disclosed in this specification pertains to oil-in-water emulsions using sweet flour and preferably sweet corn flour. Preferably, in embodiments, the disclosed oil-in-water emulsions comprise pulse-protein. The emulsions described in this specification have long term stability against oil and water separation as shown by consistency of the size of oil droplets in the emulsion over time.

Within this specification the term “sweet flour” means flour obtained from an endosperm of a cereal, grain or kernel comprising a recessive sugary-1 gene, which can be abbreviated Su-1 as the dominant allele, and su-1 as the recessive allele. Although not intended to be limiting as to a source for sweet flour, a useful source for sweet flour is sweet corn. Flours obtained from sweet corn are referred to in this specification as “sweet corn flour”. A sugary-1 recessive corn, called within this specification a sweet corn, is available as the silver queen variant of corn. The sugary-1 gene is known and its role in the biosynthesis of starch has been studied by others. (See e.g. James, M. G., et al, “Characterization of the maize gene sugaryl, a determinant of starch composition in kernels,” Plant Cell vol. 7, pp. 417-429 (1995).) The following is provided to further describe sweet flours but is not intended to limit the full understanding of the effect of a recessive sugary-1 gene in the starch biosynthesis pathway. The recessive sugary-1 gene interferes with the normal synthesis of starch. With reference to sweet corn, a significant portion of the starch in sweet corn kernel (sometimes greater 70%) has an abnormal chemical structure, being in the form of starch polymers having substantially more alpha-1-6 linkages between glycosides than is common in typical forms of amylopectin or amylose. The abnormal starch polymers of the sugary-1 mutant do not form granules (as is common of amylose and amylopectin). Also, the abnormal starch polymers of the sugary-1 mutant are soluble in water without the further processing typically required to solubilize starch in water: in other words they are soluble without prior gelatinization of the starch granule.

Sweet flour and sweet corn flour may be obtained by milling sweet grains or sweet corn kernels to obtain a flour. Sweet flour, like other flours, contains polysaccharides, lipids, proteins, and ash. Sweet flour differs from most flours, however, by naturally having substantial soluble starch. Within this specification, sweet flour and sweet corn flour have enough protein to be classified as flour instead of starch. In the broadest sense sweet corn flours have at least 0.5% (wt. %). In preferred embodiments, sweet flours and sweet corn flours have protein content greater than about more than 8% protein in an unprocessed milled product, which are called in this specification unclarified sweet flour or unclarified sweet corn. In other preferred embodiments a sweet flour or sweet corn flour has from 2% to 8% to protein in a clarified product and is called clarified sweet flour or clarified sweet corn flour in this specification.

Within this specification both unclarified and clarified sweet flour are referred to by the generic term sweet flour. Also, within this specification both unclarified and clarified sweet corn flour are referred to by the generic term sweet corn flour.

In any embodiment described in this specification, sweet flour, preferably a sweet corn flour, comprises from 70% to 80% by weight soluble starch. In any embodiment described in this specification, sweet flour comprises from about 8% to about 14% or from about 8% to about 12% protein. In any embodiment described in this specification, sweet flour comprises from about 10% to about 30% granular starch (amylose and sweet corn flour) by weight of the flour, or about 13% to about 30% or about 20% to about 30%. Lipids, ash, and other sugars may also be present but in amounts of 1% or less by weight of the flour. Granular starch and protein are generally insoluble without further processing.

In any embodiment described in this specification, a sweet flour may be clarified to remove at least some protein and granular starch. In any embodiment described in this specification, a sweet flour may be clarified by filtration or centrifugation or other known to separate components of starch, soluble material, protein, etc., within a flour. Using centrifugation, for example, soluble components remain in the supernatant and can be poured from the insoluble components. In any embodiment a clarified sweet flour is not high pressure filtered (using for example, microfiltration, ultrafiltration, or reverse osmosis filtration) to obtain a more uniform composition.

In any embodiment described in this specification a clarified sweet flour or clarified sweet corn flour has a polydispersity index greater than 0.35, or greater than about 0.37, or from about 0.37 about 0.43. In any embodiment described in this specification the soluble starch within a clarified sweet flour or clarified sweet corn flour described in this specification has a polydispersity index greater than 0.35, or greater than about 0.37, or from about 0.37 about 0.43

In any embodiment a clarified sweet flour or clarified sweet corn has a mean particle size of from 100 to 200 nm or from 100 to 150 nm, or from 120 to 140 nm. In any embodiment the soluble starch in a clarified sweet flour or clarified sweet corn has a mean particle size of from 100 to 200 nm or from 100 to 150 nm, or from 120 to 140 nm. Polydispersity index and mean particle size can be measured in solution using dynamic light scattering.

In any embodiment described in this specification, clarified sweet flour comprises from about 85% to about 95% soluble starch. In any embodiment described in this specification, clarified sweet flour comprises from about 85% to about 90% soluble starch by weight of the flour. In any embodiment described in the specification, a clarified sweet flour is preferably a clarified sweet corn flour.

In any embodiment described in this specification, clarified sweet flour has sweet corn protein content in an amount greater than about 3% by weight of the flour. In any embodiment described in this specification, clarified sweet flour has sweet corn protein content in an amount from about 4% to about 9% by weight of the flour. In any embodiment described in this specification, clarified sweet flour has a sweet corn protein content of from about 4% to about 6% by weight of the flour. In any embodiment described in this specification a clarified sweet flour has less insoluble starch content than sweet flour. In any embodiment a clarified sweet flour has insoluble starch content of less than about 5% by weight of the flour.

The sweet flours, including clarified and unclarified sweet flour, described in this specification and the sweet corn flours, including clarified and unclarified sweet flour, described in this specification are useful to stabilize emulsions. In preferred embodiments the emulsions are food compositions. In preferred embodiments the emulsions comprise a pulse-protein based emulsifier. In preferred embodiments the oil-in-water emulsions described in this specification comprise a pulse-protein and an unclarified sweet corn flour. In preferred embodiments the oil-in-water emulsions use the pulse protein as an emulsifier and the unclarified sweet corn flour as a stabilizer. In at least some embodiments the pulse protein and sweet corn flour can be mixed to form an emulsifier that is used as an emulsifier composition in an oil-in-water emulsion. In at least some embodiments the pulse protein and sweet corn flour are mixed and dried to form a powdered pulse-protein emulsifier composition.

Within this specification, pulse proteins for use in emulsions may come from any pulse. Preferred pulses are from pea or chick pea. Pulse proteins may be functionalized to have emulsifying function, for example by increasing the solubility of the pulse protein. A soluble pulse protein can be obtained by modifying a base pulse protein using, for example by deamidating the protein (for example by applying a glutaminase enzyme to the protein) or by hydrolyzing the protein to obtain smaller peptides. Alternately, some portions of pulse proteins are naturally soluble in water and can be obtained in a process that soaks a pulse or pulse flour in water. For example, pulse proteins that are useful in emulsifier compositions or oil-in-water emulsions can be obtained by cooking a pulse or pulse flour in water and then straining the solids from the cooking water. The retained cooking water yields a useful pulse-protein emulsifier having pulse protein content from about 1% to 5%. Measured using the Brix scale the cooking water having the pulse-protein has solids content measured in Brix of from about 5° to about 10°, or from about 5° to about 9°, or from about 5° to about 8°, or from about 5° to about 7°, or from about 6° to about 8°, or from about 6° to about 9°, or from about 6° to about 8° Brix.

In any embodiment, this specification describes an emulsion of oil and water comprising: oil in an amount from about 20% to about 80% or in an amount in a range selected from the group consisting of i. from about 20% to about 65%, or from about 20% to about 50%, or from about 20% to about 40%; and ii. from about 65% to about 80% by weight of the emulsion, or from about 70% to about 80%, or from about 70% to about 75%; a pulse, or pea protein, or chickpea protein in an amount of about 0.15% to about 1.0% or from 0.15% to about 0.55%, or about 0.25% to about 0.45%, or about 0.30% to about 0.40% by weight of the emulsion; a sweet corn flour in an amount of about 0.1% to about 1.0% by weight of the emulsion, or of about 0.2% to about 0.80% (w/w), or from about 0.4% to about 0.8% (w/w), or from about 0.5% to about 0.8% (w/w); and an aqueous ingredient; wherein optionally, the emulsion is egg free. In preferred embodiments, such emulsions the sweet corn flour is an unclarified sweet corn flour.

In the emulsions described in this specification, the sweet corn flour is dissolved in an aqueous phase of the emulsion in an amount at least about 0.10% of the emulsion (w/w) or at least about 0.15% (w/w), or at least about 0.20% (w/w) or in an amount of about 0.15% to about 0.55%, or about 0.25% to about 0.45%, or about 0.30% to about 0.40%, or about 0.15% to about 1.0%.

Embodiments of the emulsions disclosed in this specification, have a pH of less than 5 or from about 3 to about 5, or from about 2.5 to about 7. Embodiments of emulsions disclosed in this specification have a viscosity of from about 10,000 to about 50,000 cP, or from about 15,000 to about 30,000 cP, or from about 15,000 to about 25,000 cP. Embodiments of the emulsions disclosed in this specification have a mean oil droplet size from about 5 microns to about 20 microns, or from about 5 microns to about 15 microns or from about 10 to about 15 microns.

Embodiments of the emulsions disclosed in this specification are stable by reference to changes in oil-droplet size over time. Within this specification oil droplet size can be measured using a particle size analyzer and is reported as a diameter, in microns, of the oil droplet size. Also, mean oil droplet size is reported as a volume mean diameter, that is the mean droplet is reported diameter of a droplet having mean size measured with reference to the volume of oil droplets in the container.

In any embodiment described in this specification, an emulsion comprises enough sweet corn flour to the oil-in-water emulsion for up to six months or up to one year with reference to change in oil droplet size. In any embodiment described in this specification an emulsion has a mean oil droplet size within the emulsion that changes by less than about 5 microns for at least one month. In any embodiment described in this specification an emulsion has a variation of a mean oil droplet size (volume mean) that changes by less than about 5 microns over 1 month's storage at one or more of 5° C. or 25° C. In any embodiment described in this specification an emulsion has variation of a mean oil droplet size that changes by less than about 5 microns over 6 months when stored at one or more of 5° C. or 25° C.

In various embodiments the viscosities and stabilities described in this specification are obtained without the use of hydrocolloid or starch other than from the emulsifier and the sweet corn flour.

The emulsions described in this specification are made by dispersing sweet corn flour in an aqueous pulse-protein emulsifier or more generally aqueous phase to disperse the flour into the liquid. In any embodiment described in this specification the sweet corn flour is with an aqueous pulse protein or more generally at an aqueous phase at temperature of from about 90° C. to about 100° C. for up to about 10 minutes. Following dispersing the sweet corn flour in the aqueous phase oil is then added to the aqueous phase and the combination is mixed to form the emulsions.

In another aspect, this specification discloses an emulsifier composition, either liquid or dried that comprises a pulse protein and sweet corn flour. In some embodiments, this specification discloses pulse protein-based emulsifier composition comprising: a pulse protein, or pea protein, or chickpea protein in an amount of about 1% to about 3% of the emulsifier mixture; and a sweet corn flour in an amount of about 2% to about 5% or from about 3% to about 4% of the emulsifying mixture; wherein, the composition is a liquid and wherein, preferably, the sweet corn flour is an unclarified sweet corn flour. In any embodiment of a pulse protein-based emulsifier composition has a total solids content of from about 5% to about 15% or from about 5% to about 10%.

In any embodiment, this specification discloses a powdered pulse-protein based emulsifier composition comprising: sweet corn flour in an amount from about 50% to about 90% (wt. %) and a pulse protein in an amount from about 10% to about 50% (wt. %).

In any embodiment, this specification discloses a powdered pulse-protein based emulsifier composition made by a process comprising: mixing a pulse protein, or pea protein, or chickpea protein in an amount of about 1% to about 3% of the emulsifier mixture; and a sweet corn flour in an amount of about 2% to about 5% or from about 3% to about 4% of the emulsifying mixture and drying the mixture wherein, preferably, the pulse protein in the pulse protein emulsifier is from chickpea or pea wherein, preferably, the sweet corn flour is an unclarified sweet corn flour. In some embodiments the described powdered pulse protein-based emulsifier composition is dried by spray drying. In other embodiments the described powdered pulse protein-based emulsifier composition is dried by drum drying.

In various embodiments, a method of making an oil-in water emulsion comprises mixing a powdered pulse-protein based emulsifier as described in any foregoing claim in an amount from about 1% to about 4%, or from about 1% to about 3% or from about 1% to about 2%, or from about 1.5% to 2% by weight of the emulsion; oil in an amount from about 20% to about 80% or in a range selected from i) from about 65% to about 80% or 70% to about 80%, or from about 70% to about 75% and an aqueous ingredient. Various embodiments of emulsion made using the foregoing method obtain an emulsion have properties as described in this specification.

Use of “about” to modify a number in this specification is meant to include the number recited plus or minus 10%. Where legally permissible recitation of a value in a claim means about the value. Use of about in a claim or in the specification is not intended to limit the full scope of covered equivalents.

Use of “essentially” to modify a number, for example essentially 0, is meant to include minimal amounts of contaminant below a specifically recited amount. The amount of contaminant may or may not be measurable.

Recitation of the indefinite article “a” or the definite article “the” in this specification is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

All publications, patent applications, issued patents, and other documents (for example, journals, articles and/or textbooks) referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The technology disclosed in this specification can be better understood with reference to the following aspects, which are intended to be illustrative and do not limit the full scope of the technology disclosed.

1. An emulsion of oil and water comprising: oil in an amount from about 20% to about 80% or in an amount in a range selected from the group consisting of from about 20% to about 65%, or from about 20% to about 50%, or from about 20% to about 40%; and from about 65% to about 80% by weight of the emulsion, or from about 70% to about 80%, or from about 70% to about 75%; a pulse, or pea protein, or chickpea protein in an amount of about 0.15% to about 1.0% or from 0.15% to about 0.55%, or about 0.25% to about 0.45%, or about 0.30% to about 0.40% by weight of the emulsion; a sweet corn flour in an amount of about 0.1% to about 1.0% by weight of the emulsion, or of about 0.2% to about 0.80% (w/w), or from about 0.4% to about 0.8% (w/w), or from about 0.5% to about 0.8% (w/w); and an aqueous ingredient; optionally wherein the emulsion is egg free; optionally wherein the sweet corn flour is an unclarified sweet corn flour.

2. The emulsion of claim 1 wherein the emulsion does not comprise a hydrocolloid or modified starch.

3. The emulsion of claim 1 or 2 wherein the emulsion does not comprise a starch other than the sweet corn flour.

4. The emulsion of any one of claims 1 to 3 having a pH of less than 5 or from about 3 to about 5, or from about 2.5 to about 7.

5. The emulsion of any one of claims 1 to 4 having a viscosity of from about 10,000 to about 50,000 cP, or from about 15,000 to about 30,000 cP, or from about 15,000 to about 25,000 cP.

6. The emulsion of any one of claims 1 to 5 wherein the sweet corn flour content in sufficient amount to stabilize an oil-in-water emulsion for up to six months or up to one year.

7. The emulsion of any one of claims 1 to 6 having a mean oil droplet size from about 5 microns to about 20 microns, or from about 5 microns to about 15 microns or from about 10 to about 15 microns.

8. The emulsion of any one of claims 1 to 7 having a mean oil droplet size within the emulsion that changes by less than about 5 microns for at least one month.

9. The emulsion of any one of claims 1 to 8 having a variation of a mean oil droplet size (volume mean) that changes by less than about 5 microns over 1 month's storage at one or more of 5° C. or 25° C.

10. The emulsion of claims 1 to 9 having variation of a mean oil droplet size that changes by less than about 5 microns over 6 months when stored at one or more of 5° C. or 25° C.

11. The emulsion of any one of claims 1 to 10 wherein the sweet corn flour is dissolved in an aqueous phase of the emulsion in an amount at least about 0.10% of the emulsion (w/w) or at least about 0.15% (w/w), or at least about 0.20% (w/w) or in an amount of about 0.15% to about 0.55%, or about 0.25% to about 0.45%, or about 0.30% to about 0.40%, or about 0.15% to about 1.0%.

12. Use of sweet corn flour to provide long term stability to an emulsion wherein the sweet corn flour is dissolved in an aqueous phase of the emulsion in an amount at least about 0.10% of the emulsion (w/w) or at least about 0.15% (w/w), or at least about 0.20% (w/w) or in an amount of about 0.15% to about 0.55%, or about 0.25% to about 0.45%, or about 0.30% to about 0.40%, or about 0.15% to about 1.0% optionally wherein the sweet corn flour is an unclarified sweet corn flour.

13. The use as recited in claim 12 wherein the emulsion is egg-free and wherein the pulse, or pea protein, or chickpea protein in the emulsion is an and is used in an amount of about 0.15% to about 1.0%, or about 0.15% to about 0.55%, or about 0.25% to about 0.45%, or about 0.30% to about 0.40% by weight of the emulsion.

14. The use as recited in claim 12 or 13 wherein the emulsion further comprises and oil in an amount from about 20% to about 80% or in an amount in a range selected from the group consisting of from about 20% to about 65%, or from about 20% to about 50%, or from about 20% to about 40%; and from about 65% to about 80% by weight of the emulsion, or from about 70% to about 80%, or from about 70% to about 75%.

15. The use as recited in any one of claims 12 to 14 wherein the emulsion does not comprise a hydrocolloid or modified starch.

16. The use as recited in any one of claims 12 to 15 having pH of less than 5 or from about 3 to about 5, or from about 2.5 to about 7.

17. The use as recited in any one of claims 12 to 16 wherein the emulsion has a viscosity of from about 10,000 to about 50,000 cP, or from about 15,000 to about 30,000 cP, or from about 15,000 to about 25,000 cP.

18. The use as recited in any one of claims 12 to 17 wherein the emulsion has a mean oil droplet size from about 10 microns to about 20 microns, or from about 10 microns to about 17 microns or from about 10 microns to about 15 microns.

19. The use as recited in any one of claims 12 to 18 wherein the emulsion has a variation of a mean oil droplet size of less that changes by less than about 5 microns over 1 month's storage at one or more of 5° C. or 25° C.

20. The use as recited in any one of claims 12 to 19 wherein the emulsion has variation of a mean oil droplet size that changes by less than about less than about 5 microns over 6 months when stored at one or more of 5° C. or 25° C.

21. A method of making emulsion comprising: mixing an oil in an amount from about 20% to about 80% or in an amount in a range selected from the group consisting of from about 20% to about 65%, or from about 20% to about 50%, or from about 20% to about 40%; and from about 65% to about 80% by weight of the emulsion, or from about 70% to about 80%, or from about 70% to about 75% an aqueous ingredient, and an emulsifier mixture in an amount from 10% to 30% of the of the emulsion, or about 10% to about 25%, or about 15% to about 25%, or about 15% to about 20% wherein the emulsifier mixture is an aqueous mixture comprising: a pulse, or pea protein, or chickpea protein in an amount of about 1% to about 3% of the emulsifier mixture; and a sweet corn flour in an amount of about 2% to about 5% or from about 3% to about 4% of the emulsifying mixture; and optionally wherein the emulsion does not comprise egg; optionally wherein the sweet corn flour is an unclarified sweet corn flour.

22. The method of claim 21 wherein the emulsifier the pulse protein, or pea protein, or chickpea protein is provided by an aqueous solution; optionally wherein the pulse protein is a chickpea protein.

23. The method of 21 or 22 wherein the emulsifier mixture is obtained by heating sweet corn flour in the aqueous pulse protein, or pea protein, or chickpea protein solution.

24. The method of any one of claims 21 to 23 wherein the emulsifier mixture is obtained by heating the aqueous pulse protein, or pea protein, or chickpea protein solution and sweet corn flour at a temperature of from about 90° C. to about 100° C. for up to about 10 minutes.

25. The method of any one of claims 21 to 24 wherein the emulsifier mixture is obtained by mixing a sweet corn flour aqueous chickpea protein solution, having a Brix of from about 5° to about 10°, or from about 5° to about 9°, or from about 5° to about 8°, or from about 5° to about 7°, or from about 6° to about 8°, or from about 6° to about 9°, or from about 6° to about 8° Brix.

26. The method of any one of claims 21 to 25 wherein the emulsifier mixture has a total dissolved solids content of from about 5% to about 15% or from about 5% to about 10%.

27. The method of any one of claims 21 to 26 wherein the method does not comprise adding hydrocolloid or modified starch to the emulsion.

28. The method of any one of claims 21 to 27 wherein the method does not comprise adding a hydrocolloid or modified starch.

29. The method of any one of claims 21 to 28 wherein the method does not comprise adding a starch other than the sweet corn flour.

30. A pulse protein-based emulsifier composition comprising: a pulse protein, or pea protein, or chickpea protein in an amount of about 1% to about 3% of the emulsifier mixture; and a sweet corn flour in an amount of about 2% to about 5% or from about 3% to about 4% of the emulsifying mixture; wherein, the composition is a liquid; optionally wherein the sweet corn flour is an unclarified sweet corn flour.

31. The pulse protein-based emulsifier composition of claim 30 wherein the pulse protein, or pea protein, or chickpea protein is provided by an aqueous chickpea protein solution.

32. The pulse protein-based emulsifier composition of claim 30 or 31 having a total solids content of from about 5% to about 15% or from about 5% to about 10%.

33. The pulse protein-based emulsifier composition of any one of claims 30 to 32 wherein the composition does not comprise adding a hydrocolloid or modified starch.

34. The pulse protein-based emulsifier composition of any one of claims 30 to 33 wherein the composition does not comprise adding a starch other than the sweet corn flour.

35. The pulse protein-based emulsifier composition of any one of claims 30 to 34 consisting essentially of an aqueous chickpea protein solution, and the sweet corn flour.

36. The pulse protein-based emulsifier composition of claims 30 to 35 consisting of an aqueous chickpea protein solution and the sweet corn flour.

37. A powdered pulse-protein based emulsifier composition comprising: sweet corn flour in an amount from about 50% to about 90% (wt. %) and a pulse protein in an amount from about 10% to about 50% (wt. %).

38. The powdered pulse protein-emulsifier composition of claim 37 made by a process comprising: mixing a pulse protein, or pea protein, or chickpea protein in an amount of about 1% to about 3% of the emulsifier mixture; and a sweet corn flour in an amount of about 2% to about 5% or from about 3% to about 4% of the emulsifying mixture optionally wherein the pulse protein in the pulse protein emulsifier is from chickpea or pea; optionally wherein the sweet corn flour is an unclarified sweet corn flour.

39. The pulse-protein based emulsifier of claim 37 or 38 obtained by a processes wherein the aqueous mixture is dried by spray drying.

40. The pulse-protein based emulsifier of any one of claims 37 to 39 obtained by a process wherein the aqueous mixture is dried by drum drying.

41. A method of making an oil-in water emulsion comprising: mixing a powdered pulse-protein based emulsifier as described in any foregoing claim in an amount from about 1% to about 4%, or from about 1% to about 3% or from about 1% to about 2%, or from about 1.5% to 2% by weight of the emulsion; oil in an amount from about 20% to about 80% or in a range selected from i) from about 65% to about 80% or 70% to about 80%, or from about 70% to about 75% and an aqueous ingredient optionally wherein the emulsion is egg free.

42. The method of claim 41 wherein a gum or is not added to the emulsion.

43. The method of claim 41 or 42 wherein the aqueous ingredient has a pH of less than 7 or less than about 6 or from about 3 to about 6.

44. The method of any one of claims 41 to 43 wherein the emulsion obtained has a mean oil droplet size from about 10 microns to about 20 microns, or from about 10 microns to about 17 microns or from about 10 microns to about 15 microns.

45. The method of any one of claims 41 to 44 wherein the emulsion obtained has a has a variation of a mean oil droplet size of less that changes by less than about 12.5% or, about less than 10%, or less than about 7%, or less than about 5%, or less than about 2% over 1 month's or 6 month's or 1 year's storage at one or more of 5° C. or 25° C.

46. The method of any one of claims 41 to 45 wherein the emulsion obtained has a variation of a mean oil droplet size that changes by less than about 5 microns over 6 months or 1 year when stored at one or more of 5° C. or 25° C.

47. The method of any one of claims 41 to 46 wherein the pulse-protein based emulsifier is mixed with an aqueous ingredient prior to mixing with oil.

48. The method of any one of claims 41 to 47 wherein the pulse-protein based emulsifier is mixed with the aqueous ingredient prior to mixing with oil.

49. Use of a pulse-protein based emulsifier as described in any foregoing claim in a food composition.

50. Use of a powdered pulse-protein based emulsifier as described in claim 49 wherein the food composition is oil-in-water emulsion; optionally wherein the emulsion is egg free.

51. Use of a powdered pulse-protein based emulsifier as described in claim 49 or 50 wherein the food composition is an oil in water emulsion having oil content (by weight of the emulsion of at least about 70%, or at least about 75%, or from about 70% to about 80%).

52. Use of a powdered pulse-protein based emulsifier as described in any one of claims 49 to 51 in an amount of selected from the group consisting of: a) from about 1% to about 4%, or from about 1% to about 3%, or from about 1% to about 2%, or from about 1.5% to about 2% by weight of the emulsion, and b) or from about 3% to about 4% by weight of the emulsion.

53. Use of a powdered pulse-protein based emulsifier as descried in any one of claims 49 to 52 wherein the emulsion has a mean oil droplet size from about 10 microns to about 20 microns, or from about 10 microns to about 17 microns or from about 10 microns to about 15 microns.

54. Use of a powdered pulse-protein based emulsifier as described in any one of claims 49 to 53 to stabilize the emulsion against separating over a period of up to about 1 month or 6 months or 1 year.

55. Use of a powdered pulse-protein based emulsifier as described in any one of claims 49 to 54 wherein the emulsion stability is determined by a variation of mean oil droplet size within the oil in water emulsion of less that about 5 microns over 6 months' or 1 year's storage.

56. Use of a powdered pulse-protein based emulsifier as described in any one of claims 49 to 55 to stabilize the emulsion against separating over a period of up to about 6 months or 1 year.

57. Use of a powdered pulse-protein based emulsifier as described in any one of claims 49 to 56 wherein the emulsion has a variation of a mean oil droplet size that changes by less than about 5 microns over 6 months or 1 years when stored at one or more of 5° C. or 25° C.

The technology disclosed in this specification can be better understood with reference to the following examples, which are intended to be illustrative do not limit the full scope of the technology disclosed.

### Example 1—Oil-In-Water Emulsions Using Sweet Corn Flour Stabilizer

A high fat oil-in-water emulsions (71% soybean oil (wt. %)) were made to evaluate the ability of sweet corn flour to stabilize the emulsion compared to a high fat emulsion that does not comprise sweet corn flour. Both emulsions used chickpea protein available from Ingredion Incorporate as the emulsifier. The chickpea protein is a liquid composition that had protein content of from about 3% (wt. %) chickpea protein in aqueous solution. The formulas for both emulsions are set forth in Table 1.

TABLE 1
Formulas for Spoon-able Dressing Stability
Testing Using Sweet Corn Flour

| | |
|---|---|
| | Comprising Sweet |
| Control | Corn Flour |

| Ingredient | % | (g) | % | (g) |
|---|---|---|---|---|
| Water | 0 | 0 | 3.2 | 64 |
| Sugar | 3 | 60 | 3 | 60 |
| Vinegar (120 Grain) | 3 | 60 | 3 | 60 |
| Potassium Sorbate | 0.1 | 2 | 0.1 | 2 |
| Corn flour | 0 | 0 | 0.7 | 14 |
| Salt | 1 | 20 | 1 | 20 |
| Aquafaba | 17.9 | 358 | 18 | 360 |
| Soybean Oil | 75 | 1500 | 71 | 1420 |
| Total | 100 | 2000 | 100 | 2000 |

The emulsions were made as follows. For control, all ingredients except oil were mixed at low agitation in Hobart type mixer. Oil was added and emulsified in a two-step process that first mixes ingredients in a Hobart type mixer at low speed to form a course emulsion and then mixes the course emulsion at high shear in a high shear mixer or colloid mill to homogenize and finish the emulsion. For samples using sweet corn flour, the sweet corn flour was unclarified and was mixed with the aqueous chickpea protein dispersion. The mixture was heated in a 100° C. water bath for 10 minutes with light agitation. Emulsions are stored in containers at room temperature 25° C. and 5° C. for up to six months.

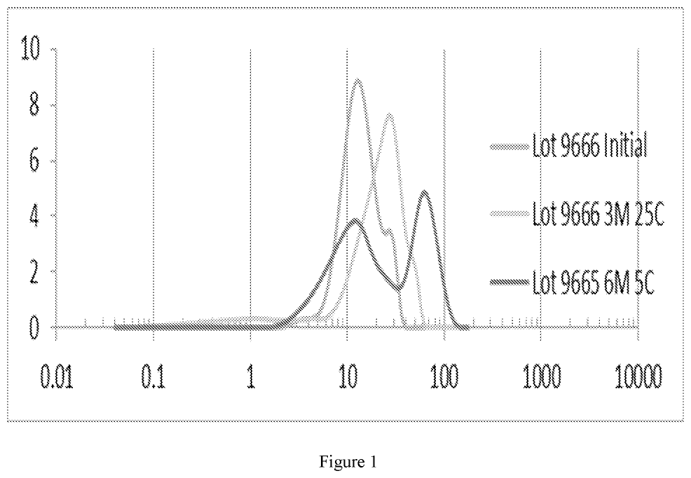

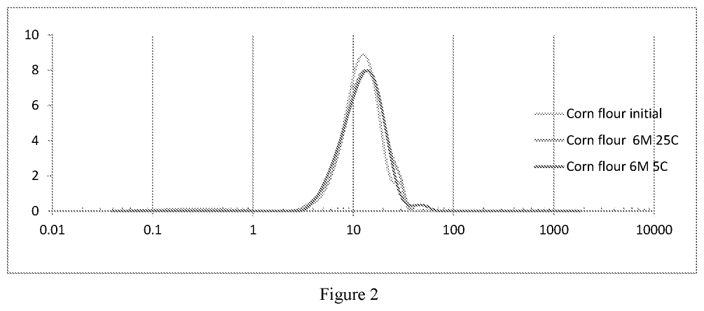

Emulsions were evaluated for stability by comparing change oil-droplet size of the initial emulsion compared to stored emulsion. Oil droplet size was measured using Beckman Coulter LS 13 320 SLS particle size analyzer. Oil droplet size distribution for control emulsions is reported in FIG. 1. Oil droplet size distribution for emulsions comprising sweet corn flour is reported in FIG. 2. In both Figures, the oil droplet size is a diameter measured in microns of the oil droplet and is reported on the horizontal axis in logarithmic scale. The vertical-axis reports the percent (by volume of the sample) of droplets having the diameter reported on the horizontal-axis.

As seen in FIG. 1, control oil-in-water emulsions that did not comprise sweet corn flour had substantial variation in oil droplet size between initial emulsions and samples stored at 25° C. for 3 months and samples stored at 5° C. for six months. For comparison, as seen in FIG. 2, oil-in-water emulsions comprising sweet corn flour had similar oil droplet size, comparing the initial sample and the samples stored for 6 months storage at 5° C. or 25° C.

1. An emulsion of oil and water comprising:
a. oil in an amount from about 20% to about 80%
b. a pulse protein in an amount of about 0.15% to about 1.0%;
c. a sweet corn flour in an amount of about 0.1% to about 1.0% by weight of the emulsion; and
d. an aqueous ingredient.

2. The emulsion of claim 1 wherein the emulsion does not comprise a hydrocolloid or modified starch.

3. The emulsion of claim 1 wherein the emulsion does not comprise a starch other than the sweet corn flour.

4. The emulsion of claim 1 having a pH of less than 5.

5. The emulsion of claim 1 having a viscosity of from about 10,000 to about 50,000 cP.

6. The emulsion claim 1 wherein the sweet corn flour content in sufficient amount to stabilize an oil-in-water emulsion for up to six months.

7. The emulsion of claim 1 having a mean oil droplet size from about 5 microns to about 20 microns.

8. The emulsion of claim 1 having a mean oil droplet size within the emulsion that changes by less than about 5 microns for at least one month.

9. The emulsion of claim 1 having a variation of a mean oil droplet size (volume mean) that changes by less than about 5 microns over 1 month's storage at one or more of 5° C. and 25° C.

10. The emulsion of claim 1 having variation of a mean oil droplet size that changes by less than about 5 microns over 6 months when stored at one or more of 5° C. and 25° C.

11. The emulsion of claim 1 wherein the sweet corn flour is dissolved in an aqueous phase of the emulsion in an amount at least about 0.10% of the emulsion (w/w).

12. (canceled)

13. A method of making emulsion comprising:
a) mixing an oil in an amount from about 20% to about 80%
b. an aqueous ingredient, and
c. an emulsifier mixture in an amount from 10% to 30% of the of the emulsion,
wherein the emulsifier mixture is an aqueous mixture comprising: a pulse protein, in an amount of about 1% to about 3% of the emulsifier mixture; and a sweet corn flour in an amount of about 2% to about 5%.

14. The method of claim 13 wherein the emulsifier the pulse protein is provided by an aqueous solution.

15. The method of 13 wherein the emulsifier mixture is obtained by heating sweet corn flour in the aqueous pulse protein.

16. The method of claim 13 wherein the emulsifier mixture is obtained by heating the aqueous pulse protein and sweet corn flour at a temperature of from about 90° C. to about 100° C. for up to about 10 minutes.

17. The method of claim 13 wherein the emulsifier mixture has a total dissolved solids content of from about 5% to about 15%.

18. The method of claim 13 wherein the method does not comprise adding hydrocolloid or modified starch to the emulsion.

19. The method of claim 13 wherein the method does not comprise adding a hydrocolloid or modified starch.

20. The method of claim 13 wherein the method does not comprise adding a starch other than the sweet corn flour.
